(19) United States
(12) Patent Application Publication
(10) Pub. No.: US 2006/0125758 A1
(43) Pub. Date: Jun. 15, 2006

(54) Driving circuit for display apparatus, flexible printed circuit, and active matrix display apparatus

(76) Inventors: Kuni Yamamura, Anpachi-gun (JP); Michiru Senda, Gifu-shi (JP); Ryoichi Yokoyama, Ohgaki-shi (JP); Yasushi Miyajima, Gifu-shi (JP); Toshihiko Tanaka, Anpachi-gun (JP)

Correspondence Address: CANTOR COLBURN, LLP, 55 GRIFFIN ROAD SOUTH, BLOOMFIELD, CT, 06002, US

(21) Appl. No.: 11/288,742

(22) Filed: Nov. 29, 2005

(30) Foreign Application Priority Data
Nov. 30, 2004 (JP) 2004-346825
Nov. 30, 2004 (JP) 2004-346844

(51) Int. Cl. G09G 3/36

(52) U.S. Cl. 345/98

(57) ABSTRACT

A driving circuit of an LCD display apparatus, which adjusts the sampling timing of a video signal. Driving signals from a driving IC and a reference power source are supplied via a flexible printed circuit FPC to an LCD panel. A horizontal clock signal is subjected to switching adjustment in a propagation delay adjustment circuit, which alternatively switches a delay amount of the horizontal clock signal between two levels, and the resulting horizontal clock signal subjected to the switching adjustment is then supplied to a horizontal shift register. The FPC generates a switching signal by branching from either a high potential voltage signal VDD or a low potential voltage signal VSS and supplies the switching signal to the propagation delay adjustment circuit. A phase switching circuit having a function similar to that of the propagation delay adjustment circuit may be provided within the driving IC.

The disclosure of Japanese Patent Application Nos. 2004-346825 and 2004-346844 including the specification, claims, drawings and abstract is incorporated herein by reference, in its entirety.

### BACKGROUND OF THE INVENTION

1. Field of the Invention

The present invention relates to a driving circuit for a display apparatus and so on, and more particularly to timing adjustment of a sampling clock signal for driving an active matrix display apparatus such as a liquid crystal display apparatus.

2. Description of Related Art

Liquid crystal display apparatuses are advantageous in that they are thin and light-weight, and consume a low amount of power and are therefore used in a variety of devices.

Generally, in an active matrix liquid crystal display apparatus, a video signal (an analog video signal or a digital video signal) and a clock signal from a driving IC and a driving voltage signal from a power source are supplied to a display panel via a FPC (Flexible Printed Circuit). In a liquid crystal panel, a thin film transistor (TFT) serving as a switching element is provided for each pixel, and ON/OFF of the pixel TFTs is controlled by gate lines extending in the row direction while display data is supplied to each pixel via data lines extending in the column direction. A vertical driver (V driver) for sequentially controlling the gate lines and horizontal driver (H driver) for supplying the display data to the data lines at predetermined timing are provided in the peripheral region of the display section of the liquid crystal panel. The H driver includes a horizontal shift register (HSR) for sequentially shifting a horizontal start signal (HST) in accordance with a horizontal clock signal (HCLK) and a TFT which is controlled ON and OFF by a sampling pulse supplied from the horizontal shift register for sampling a video signal at the desired timing. Here, the signal propagation characteristics within a liquid crystal panel vary among different liquid crystal panels due to a difference in the characteristics of the transistors or the like. Accordingly, even if the same clock signal is supplied from a driving circuit to different liquid crystal panels, the sampling timing of a video signal varies among the liquid crystal panels. By setting the signal propagation delay amount of the liquid crystal panel such that the sampling timing of a video signal corresponds to timing at substantially the intermediate point within an optimal sampling period of the video signal, the sampling timing can be set within the optimal sampling period even if there is some variation in the delay characteristics of the liquid crystal panels, thereby increasing the sampling hold margin and achieving adaptivity of the driving circuit to liquid crystal display panels having different signal propagation characteristics.

PCT international publication No. WO99/42989 describes a technique for adjusting the sampling timing of the A/D converter for converting an analog video signal to a digital video signal, which is similar to, but not related to, a technique for adjusting the sampling timing for sampling a video signal and supplying the video signal to the pixel TFT. A phase control circuit outputs sampling signals having four different phases within one period of the sampling clock to the A/D converter. The A/D converter samples an analog video signal using the sampling clocks having different phases and outputs an 8-bit digital signal to a video processing circuit. Here, a sampling clock having the optimal phase of the four phases is selected and set to the optimal sampling phase.

In recent years, higher driving frequencies have been required due to a demand for higher definition in liquid crystal display panels or the like, and the optimal sampling period of a video signal is being gradually shortened in accordance with such a request of the higher driving frequencies. This makes it difficult to maintain the sampling timing of a video signal within the optimal sampling period, resulting in a problem of deterioration of the image quality or reduction in yield due to a shift of the sampling timing.

As one solution, a method in which a plurality of delay circuits having different delay time amounts are provided within the liquid crystal panel and one of the delay circuits is selected for compensating for or canceling a difference in the delay characteristics caused by a variation of the characteristics of the liquid crystal panels may be considered. This method, however, requires, in addition to a plurality of delay circuits, a circuit for selecting among the delay circuits, which makes the structure of the liquid crystal panel more complicated. Accordingly, a technique which can optimize the sampling timing with a simple structure is desired.

### SUMMARY OF THE INVENTION

The present invention provides a driving circuit or the like which can compensate for a variation in the delay characteristics of display apparatuses for maintaining or increasing the image quality reliably with a simple structure.

In accordance with one aspect, the present invention provides a driving circuit for driving an active matrix display apparatus, which comprises a flexible printed circuit for supplying a high potential power source voltage signal, a low potential power source voltage signal, and a clock signal to the display apparatus. The display apparatus includes a first delay circuit which causes the clock signal supplied from the flexible printed circuit to be delayed by a first delay amount, a second delay circuit which causes the clock signal to be delayed by a second delay amount, wherein the first delay amount is less than (<) the second delay amount, and a change-over switch which selectively switches between the first delay circuit and the second delay circuit in accordance with a switching signal. The flexible printed circuit generates the switching signal by branching from either the high potential power source voltage signal or the low potential power source voltage signal and supplies the switching signal to the change-over switch.

In accordance with a further aspect, the present invention provides a flexible printed circuit which supplies a driving signal for driving an active matrix display apparatus, which comprises a high potential power source voltage signal line for supplying a high potential power source voltage signal to the display apparatus, a low potential power source voltage signal line for supplying a low potential power source voltage signal to the display apparatus, a clock signal line for supplying a clock signal to the display apparatus, and a switching signal line which is formed by branching from either the high potential power source voltage signal line or the low potential power source voltage signal line, the switching signal line supplying a switching signal which selectively switches among a plurality of delay circuits provided within the display apparatus to the display apparatus.

In accordance with a still further aspect, the prevent invention provides an active matrix display apparatus, which comprises a display panel including active matrix type pixels, and a flexible printed circuit for supplying a driving signal including a clock signal and a voltage signal for driving the display panel to the display panel. The display panel includes a first delay circuit which causes the clock signal supplied from the flexible printed circuit to be delayed by a first delay amount, a second delay circuit which causes the clock signal supplied from the flexible printed circuit to be delayed by a second delay amount, wherein the first delay amount is less than (<) the second delay amount, and a change-over switch for selectively switching between the first delay circuit and the second delay circuit in accordance with a switching signal. The flexible printed circuit includes a switching signal line for supplying the switching signal which is branched from the voltage signal to the change-over switch.

In accordance with a further aspect, the present invention provides a driving circuit for driving an active matrix display apparatus, which comprises a driving IC which outputs a clock signal, a power source which outputs a voltage signal, and a flexible printed circuit which supplies the voltage signal and the clock signal to the display apparatus and which generates a switching signal by branching from the voltage signal and supplies the switching signal to a change-over switch which is provided within the display apparatus for selectively switching between a first delay circuit which causes the clock signal supplied from the flexible printed circuit to be delayed by a first delay amount and a second delay circuit which causes the clock signal to be delayed by a second delay amount, wherein the first delay amount is less than (<) the second delay amount.

According to the present invention, the display apparatus includes the first and second delay circuits for variably setting at least two levels of delay amounts, and selection of the delay circuits is controlled by a switching signal which is supplied from the flexible printed circuit (FPC). The flexible printed circuit, which originally includes a voltage signal line for a high potential signal and a voltage signal line for a low potential signal, generates a switching signal by branching from either one of the voltage signals, and supplies the branched signal, as a switching signal, to the display apparatus. The switching signal which is branched from the high potential voltage signal alternatively operates one of the first and second delay circuits, and the switching signal which is branched from the low potential voltage signal alternatively operates the other one of the first and second delay circuits. The first delay circuit is selected when the delay amount of the display apparatus is great and the second delay circuit is selected when the delay amount of the display apparatus is small, thereby compensating for a variation in delay amounts inherent to the display apparatus.

According to the present invention, because a switching signal for switching among the plurality of delay circuits provided in the display apparatus is branched from a voltage signal in the flexible printed circuit, selection among the plurality of delay circuits can be performed with a simple structure, thereby eliminating a variation in the delay characteristics of the display apparatuses. According to the present invention, in particular, a variation in the delay amounts of the display apparatuses can be eliminated simply by selecting a flexible printed circuit in accordance with the delay characteristics of the display apparatus and connecting the selected flexible printed circuit to the display apparatus.

In the present invention, the active matrix display apparatus may be configured such that the driving IC within the driving circuit is formed as a driving IC which selectively outputs a clock signal having a different phase in accordance with a switching signal and the switching signal is supplied from the printed circuit to the driving IC.

### BRIEF DESCRIPTION OF THE DRAWINGS

Preferred embodiments of the present invention will be described in detail based on the following figures, wherein:

FIG. 1 is a view showing an overall structure of a display apparatus according to one embodiment of the present invention;

FIG. 2 is a view showing a structure of a propagation delay adjustment circuit in FIG. 1;

FIGS. 3A and 3B are views showing structures of the FPC in FIG. 1;

FIG. 4 is a view showing the structure of a horizontal shift register (HSR) and a sampling circuit in FIG. 1;

FIG. 5 is a timing chart showing the sampling timing of the embodiment;

FIG. 6 is a flowchart of a manufacturing method of the embodiment;

FIG. 7 is a view showing an overall structure of a display apparatus according to another embodiment of the present invention;

FIGS. 8A and 8B are views showing structures of the FPC in FIG. 7;

FIG. 9 is an explanatory view showing a structure in which a switching signal line is branched from a VDD signal line;

FIG. 10 is a timing chart showing the sampling timing of the embodiment;

FIG. 11 is an explanatory view showing another structure in which a switching signal line is branched from a VDD signal line; and

FIGS. 12A and 12B are explanatory views showing branching within an LCD panel.

### DETAILED DESCRIPTION OF PREFERRED EMBODIMENT

Preferred embodiments of the present invention will be described in detail with reference to the accompanying drawings.

### First Embodiment

<Overall Structure>

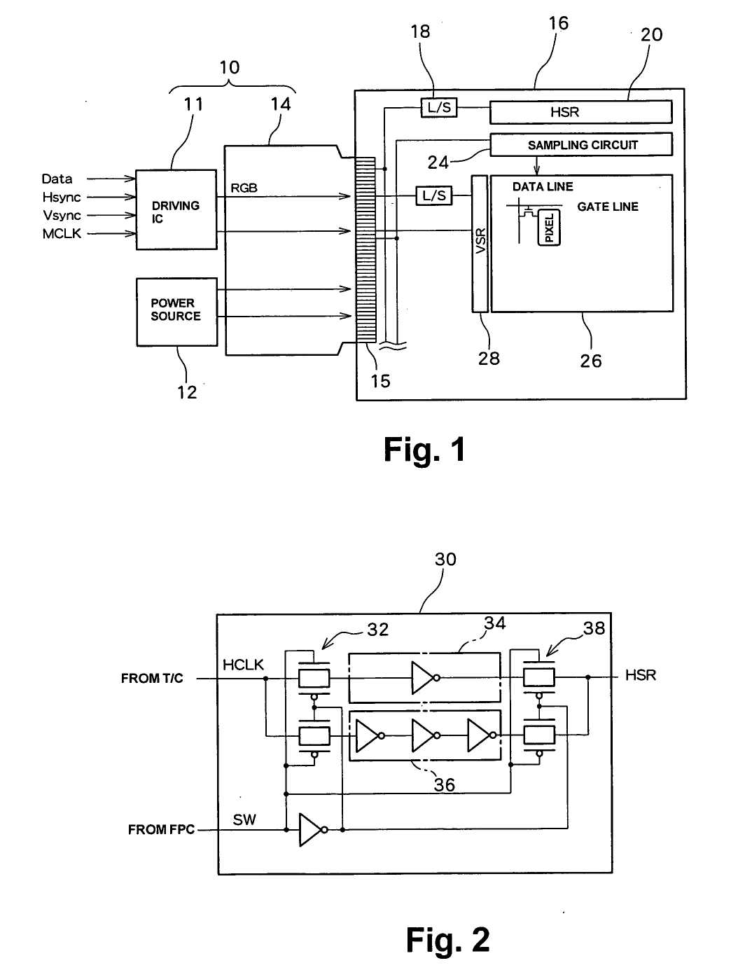

The overall structure of an active matrix display apparatus according to a first embodiment will first be described. The display apparatus shown in FIG. 1, which is a liquid crystal display apparatus mounted on a mobile telephone, for example, includes a liquid crystal display panel (LCD panel) 16 formed by sealing liquid crystal between a pair of substrates and a driving circuit 10 for driving the LCD panel 16. The driving circuit 10 receives a video signal (DATA in FIG. 1), a horizontal synchronization signal (Hsync), a vertical synchronization signal (Vsync), and a clock (MCLK) supplied thereto. The driving circuit 10 includes a driving IC 11 which generates and outputs an analog video signal (R, G, B signal) and a clock signal based on the received signals described above, a reference power source 12, and a flexible printed circuit (FPC) 14 which supplies the various driving signals supplied from the driving IC 11 and a voltage signal supplied from the reference power source 12 to the LCD panel 16.

The LCD panel 16 is an active matrix LCD panel in which a thin film transistor (TFT) is provided as a switching element in each pixel and ON and OFF of the TFTs is controlled by gate lines extending in the row direction. Display data is supplied from data lines extending in the column direction to the respective pixels via the TFTs, thereby enabling display for each pixel. In the peripheral portion of a display section 26 of the panel, a horizontal driver for supplying the display data to the data lines at predetermined timing and a vertical driver for sequentially controlling the gate lines are formed. The horizontal driver includes a horizontal shift register (HSR) 20 having a plurality of stages for sequentially shifting a horizontal start pulse in accordance with a clock signal (HCLK) supplied from the FPC 14 via a pad 15, and a sampling circuit 24 for sampling an analog video signal in accordance with a start pulse supplied from the HSR 20. The clock signal (HCLK) is subjected to level adjustment in a level shifter 18 and then supplied to the HSR 20, and a video signal sampled by the sampling circuit 24 is supplied to the data lines. The vertical driver includes a vertical shift register 28, and sequentially shifts a vertical start pulse (VST) as a vertical clock (VCLK) in accordance with the number of gate lines in the LCD panel 16, and outputs the VST which has been subjected to the predetermined logical operation to the gate lines.

The horizontal clock (HCLK) is supplied from the FPC 14 via the level shifter (L/S) 18 to the HSR 20, as described above. Here, the LCD panel 16 according to the first embodiment includes a propagation delay adjustment circuit 30 between the HSR 20 and the level shifter 18. The propagation delay adjustment circuit 30 includes a plurality of delay circuits having different delay time which are arranged in parallel, and one of the delay circuits is alternatively selected in accordance with a switching signal supplied from the FPC 14 via the pad 15 and is operated.

The driving IC 11 includes a timing controller (T/C) for generating the above-described horizontal clock (HCLK), the horizontal start pulse (HST), the vertical clock (VCLK), the vertical start pulse (VST), and so on, in accordance with Hsync and Vsync, and a dot clock (DOTCLK). The DOTCLK is supplied to an H counter via the driver circuit. The H counter counts DOTCLK in each 1H period, and outputs the count value to a decoder, which decodes the pulse signal and outputs the pulse signal as HCLK via a logical gate. Further, another decoder obtains the timing immediately before the start of 1 H period based on the count value, and generates a pulse signal. The pulse signal decoded by the decoder is also output as HST via the logical gate. VCLK and VST are also generated and output in a similar manner as described in Japanese Patent Laid-Open Publication No. 2001-356746, for example.

The reference power source 12 generates and outputs VDD (high potential power source voltage) and VSS (low potential power source voltage). The VSS may be GND. As an example, VDD is 8V, and VSS is 0V. The signals HCLK, HST, VCLK, VST and video signals R, G, and B output from the driving IC 11 and the signals VDD and VSS output from the reference power source 12 are supplied to the LCD panel 16 via the signal lines of the FPC 14.

The FPC 14 of the present embodiment further includes, in addition to the signal lines for the above-described signals, a switching signal line for supplying a switching signal to the propagation delay adjustment circuit 30 for HCLK, which is formed between the level shifter 18 and the HSR 20. The switching signal line is branched from one of the VDD signal line and the VSS signal line within the FPC 14. Which of the VDD signal line and the VSS signal line the switching signal line is branched from is set depending on which of the delay circuits within the propagation delay adjustment circuit 30 is to be operated, namely, depending on the degree of the delay characteristics of the LCD panel 16. In the first embodiment, the propagation delay characteristics of the LCD panel 16 are evaluated in accordance with two evaluation levels, i.e. “good” and “poor”, and one of the delay circuits is selectively operated in accordance with the evaluation result.

The propagation delay adjustment circuit 30 and the FPC 14 will be described in further detail.

<Propagation Delay Adjustment Circuit>

FIG. 2 shows the structure of the propagation delay adjustment circuit 30 of FIG. 1. The propagation delay adjustment circuit 30 includes a delay circuit 34 having delay time ti and a delay circuit 36 having delay time t2 (t1<t2), and further includes an input switch 32 and an output switch 38 for alternatively operating the delay circuit 34 or the delay circuit 36. While in FIG. 2 the delay circuit 34 includes one delay element (inverter) and the delay circuit 36 includes three delay elements (inverters) and t2=t1×3 is set, the delay time t1 and t2 of the delay circuits 34 and 36 may be set arbitrarily.

The input switch 32 is formed by CMOS, in which a horizontal clock HCLK is supplied to the input terminal and a switching signal SW from the FPC 14 and an inverted signal obtained by the inverter are supplied to the gate terminal. The delay circuit 34 is connected to one of the two output terminals of the input switch 32 and the delay circuit 36 is connected to the other of the two output terminals. Similarly, the delay circuit 34 is connected to one of the two input terminals of the output switch 38 and the delay circuit 36 is connected to the other of the two input terminals, and a switching signal SW and an inverted signal obtained by the inverter is supplied to the gate terminal.

When the level of the switching signal SW is H (High), the upper TFTs in both the input switch 32 and the output switch 38 are turned ON, and HCLK is supplied to the horizontal shift register HSR 20 via the delay circuit 34. The delay time of HCLK at this time corresponds to the delay time t1 of the delay circuit 34.

When the level of the switching signal SW is L (Low), on the other hand, the lower TFTs in both the input switch 32 and the output switch 38 are turned ON, and HCLK is supplied to the horizontal shift register HSR 20 via the delay circuit 36. The delay time of HCLK at this time corresponds to the delay time t2 of the delay circuit 36.

As described above, according to the first embodiment, it is possible to selectively generate HCLK having the delay time t1 or the delay time t2 in accordance with the switching signal SW supplied from the FPC 14 and to supply HCLK to the HSR 20. Accordingly, in a case where an LCD panel 16 is given and the propagation delay characteristics of the LCD panel 16 are measured, when the delay characteristics are good (i.e. within the range of normal delay amount), a switching signal having an L signal level is supplied to the LCD panel 16 such that the delay circuit 36 is to be selected, whereas when the delay characteristics are poor (i.e. the delay amount is large), a switching signal having an H signal level is supplied to the LCD panel 16 such that the delay circuit 34 is to be selected so as to compensate for the delay amount, thereby achieving adaptability to different propagation delay characteristics of the LCD panel 16.

<FPC>

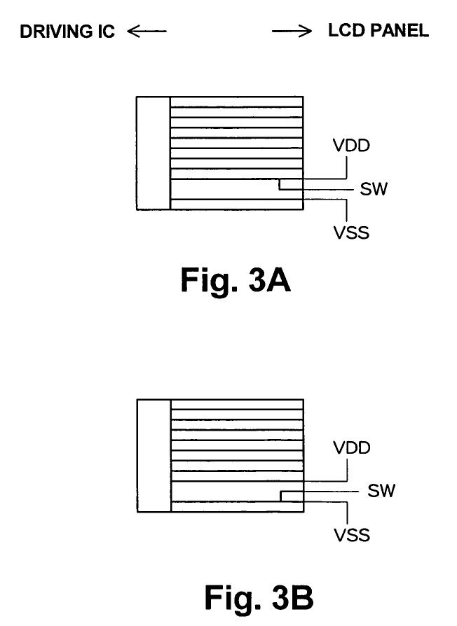

FIGS. 3A and 3B schematically show the structures of the FPC 14 of FIG. 1. As described above, the FPC 14 includes a plurality of signal lines for supplying the various signals from the driving IC 11 and the reference power source 12 to the LCD panel 16. Here, either the VDD signal line or the VSS signal line diverges in the middle to form the switching signal line, which is used for supplying the switching signal to the LCD panel 16. FIG. 3A shows a case where the switching signal line is branched from the VDD signal line and the level of the switching signal SW is a VDD level, i.e. H level. On the other hand, FIG. 3B shows a case where the switching signal line is branched from the VSS signal line and the level of the switching signal SW is a VSS level, i.e. L level. As such, selection among the plurality of (two in this embodiment) delay circuits within the propagation delay adjustment circuit 30 can be performed by setting the signal level of the switching signal SW to either H or L. Further, the FPC 14 originally includes the VDD signal line for supplying a voltage signal of high potential supplied from the reference power source 12 to the LCD panel 16 and the VSS signal line for supplying a voltage signal of low potential to the LCD panel 16. According to the present embodiment, the above features are particularly noticed, and the originally-existing signal lines within the FPC 14 are used, rather than providing an additional circuit for generating the switching signal within the LCD panel 16 or outside the LDC panel 16, thereby achieving selection of the delay circuits without unnecessarily increasing the number of elements. More specifically, the FPC 14 having the structure shown in FIG. 3A and the FPC 14 having the structure shown in FIG. 3B are prepared in advance, and when the delay characteristics of the LCD panel 16 are good as a result of measurement, the FPC 14 shown in FIG. 3B can be connected to the pad 15 of the LCD panel 16, whereas when the delay characteristics of the LCD panel 16 are poor as a result of measurement, the FPC 14 shown in FIG. 3A can be connected to the pad 15 of the LCD panel 16.

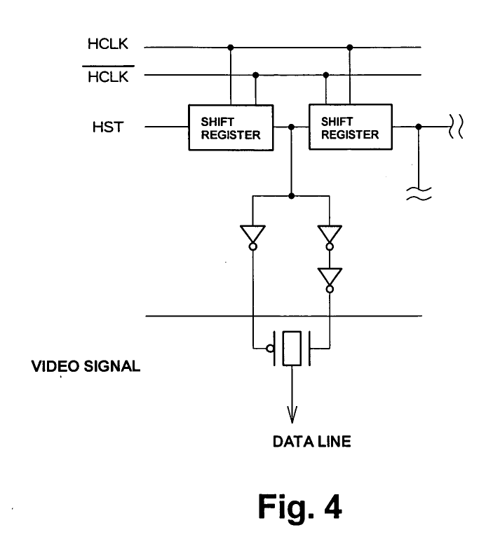

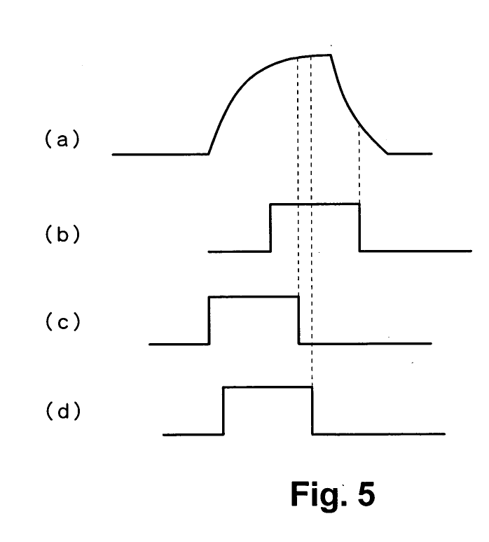

FIGS. 4 and 5 show the HSR 20 and the sampling timing of the sampling circuit 24, when the delay amount of HCLK has been adjusted by selection of the delay circuit as described above. Specifically, FIG. 4 shows the structures of the HSR 20 and the sampling circuit 25. HCLK and an inverted clock of HCLK, and a horizontal start pulse HST are supplied from the FPC 14 via the pad 15 to the shift registers forming the HSR 20. The HST, HCLK, and the inverted clock are supplied to the shift registers after having been subjected to delay adjustment in the propagation delay adjustment circuit 30. Each shift register, in accordance with HCLK, sequentially shifts HST and supplies HST to the sampling circuit 24. Here, the phase of HCLK having been subjected to delay adjustment in the delay circuit 36 is delayed by a predetermined time amount with respect to that of HCLK having been subjected to delay adjustment in the delay circuit 34. Here, if the LCD panel having good delay characteristics is assumed to be in a “default state”, HCLK having been subjected to delay adjustment in the delay circuit 36 can be expressed as a clock having a default phase and HCLK having been subjected to delay adjustment in the delay circuit 34 can be expressed as a clock having a phase which is advanced by a predetermined time amount with respect to the default phase. The sampling circuit 24 includes a switching TFT. A video signal from the FPC 14 is supplied to the input terminal of the switching TFT, and an output from the shift registers, i.e. HST which is synchronized with HCLK, is supplied, as a sampling pulse, to the gate terminal of the switching TFT via the inverters. Then, sampling of the video signal is started at the time when the sampling pulse rises to H level and video signal is supplied to the data line.

FIG. 5 is a timing chart showing the sampling timing of the video signal by the sampling pulse. The figure (a) shows the waveform of the video signal supplied to the switching TFT of the sampling circuit 24, and shows a state in which a video signal is supplied a certain pixel at certain time and then supply of a video signal is interrupted. Then, at a subsequent time, the next video signal is to be supplied to the certain pixel. The optimal sampling period is a period in which the video signal reaches a fixed level, and accurate display data can be supplied to the data line if sampling is completed within this optimal sampling period. The figure (b) shows a sampling pulse obtained when the LCD panel 16 having poor propagation delay characteristics is used. Due to the poor propagation delay characteristics of the LCD panel 16, the sampling completion timing is delayed and sampling is performed out of the optimal sampling period. In such a case, the FPC 14 having the structure shown in FIG. 3A is selected to supply a switching signal SW having a H signal level to the LCD panel 16. Consequently, the delay circuit 34 within the propagation delay adjustment circuit 30 is selectively operated in accordance with the level of the switching signal, thereby setting a delay amount of HCLK to a small amount. The figure (c) shows a sampling pulse obtained when the FPC 14 shown in FIG. 3A is used to operate the delay circuit 34. Due to a small amount of delay time, the phase of the sampling pulse is advanced, so that the sampling can be performed within the optimal sampling period in which the video signal reaches a fixed level. The figure (d) shows a sampling pulse obtained when the LCD panel 16 having good propagation delay characteristics is used and the FPC 14 shown in FIG. 3B is used to operate the delay circuit 36. In this case, contrary to the case of the figure (b), sampling can be performed within the optimal sampling period even when the delay circuit 36 is used, because the delay characteristics of the LCD panel 16 are good (i.e. the delay amount is within a predetermined range).

As described above, according to the first embodiment, the two delay circuits 34 and 36, as the propagation delay adjustment circuit 30, are provided in parallel to each other, and one of the delay circuits 34 and 36 is alternatively selected in accordance with the switching signal generated by the FPC 14, whereby the sampling timing can be adjusted adaptively in accordance with the amount of delay characteristics of the LCD panel 16. Further, because the switching signal which is used for switching the delay circuits 34 and 36 is branched from either the VDD signal or the VSS signal within the FPC 14 and then supplied, reliable switching between the delay circuits can be achieved with a simple structure and without an increase in the number of elements, in accordance with the LCD panel 16.

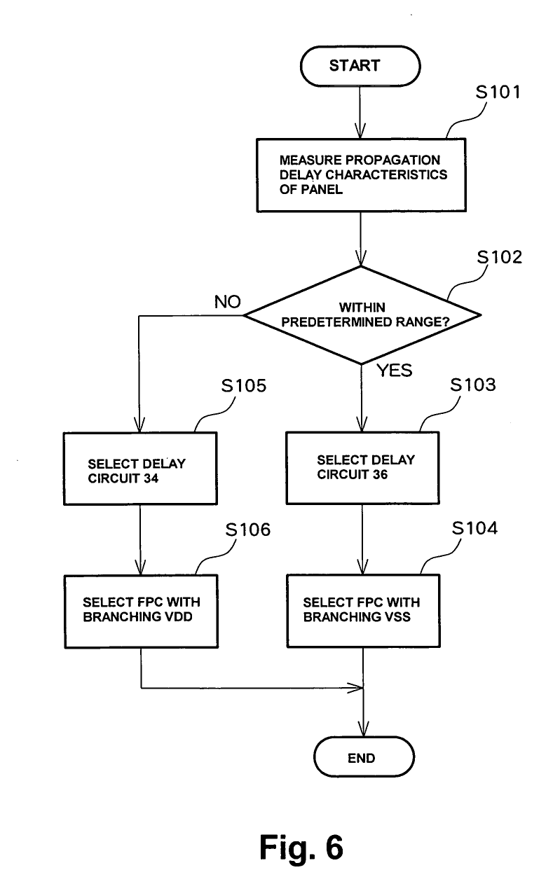

FIG. 6 shows a flowchart for manufacturing the LCD display apparatus according to the first embodiment. First, the propagation delay characteristics of the LCD panel 16 are measured (S101). The method for measuring the propagation delay characteristics is arbitrary, and may be a method in which a TEG (Test Element Group) is created and the signal delay amount is actually measured or a method in which the driving frequency is changed to cause white and black burst signals to be displayed on the LCD panel and blur of the white and black colors caused by the delay in the sampling timing is visually recognized to thereby measure the delay amount, for example.

After the measurement of the propagation delay characteristics, it is determined whether or not the delay amount falls within a predetermined range (S102). If the delay amount falls within the predetermined range, the delay circuit 36 is selected (S103). Then, the FPC 14 having the switching signal line which is branched from the VSS signal line is selected and connected to the LCD panel 16 such that the delay circuit 36 is to be selected within the LCD panel 16 (S104). If the delay amount exceeds the predetermined range, on the other hand, the delay circuit 34 is selected (S105). Then, the FPC 14 having the switching signal line which is branched from the VDD signal line is selected and connected to the LCD panel 16 such that the delay circuit 34 is to be selected within the LCD panel 16 (S106). The above-described series of processes shown in FIG. 6 can be automated. Specifically, a propagation delay characteristics evaluation section and an FPC selection section are provided, and an LCD panel 16 is supplied to the propagation delay characteristics evaluation section to evaluate the delay amount of the LCD panel 16. The delay amount thus obtained is then compared with the predetermined range. If the delay amount falls within the predetermined range, an FPC 14 is extracted from a stocker of FPCs 14 having a VSS branch signal line and connected to the LCD panel 16. If the delay amount exceeds the predetermined range, on the other hand, an FPC 14 is extracted from a stocker of FPCs 14 having a VDD branch signal line and connected to the LCD panel 16. Here, measurement of the delay amount, comparison of the delay amount to the predetermined range, and selection of the FPC 14 can be controlled by a computer.

While in the above example, the two delay circuits 34 and 36 are provided within the propagation delay adjustment circuit 30, three or more delay circuits may be provided as required. In such a case, however, because selection among the three or more delay circuits cannot be achieved by a switching signal branched from VDD and a switching signal branched from VSS as used in the above example, it is necessary to form an additional switching signal line which is branched from a further signal line.

Further, while the above example can be applied to LCD display apparatuses with high driving frequencies and high resolution, the structure of the above example may be applied to any active matrix display apparatuses independently of the driving frequencies.

Further, in the above example, one of the two types of FPCs 14 (see FIGS. 3A and 3B) is selected in accordance with the propagation delay characteristics of the LCD panel 16 and is connected to the LDC panel 16. However, it is also possible for a single FPC 14 having switching signal lines branched from both the VDD and VSS signal lines to be connected to the LCD panel 16 and one of the branches to be burned off or the like in accordance with the propagation delay characteristics of the LCD panel 16, thereby obtaining a switching signal line which is branched from either the VDD signal line or the VSS signal line.

Further, when the switching signal line is branched from either the VDD or VSS signal line, the branching point may be any point within the FPC 14. Accordingly, the switching signal line may be branched from the VSS or VDD signal line at a point which is close to the LCD panel 16 as shown in FIGS. 3A and 3B, or it is also possible to cause the switching signal line to be branched from the VDD and VSS signal lines at different points so that the two types of FPCs 14 shown in FIGS. 3A and 3B can -be discriminated easily, for example. It may be also preferable to cause the switching signal line branched from either the VDD or VSS signal line to extend in a direction different from the direction of the other signal line which is not branching, so as to prevent short-circuit with respect to the other signal line. For example, rather than causing the signal line branched from the VDD signal line to extend between the VDD and the VSS lines as in the example shown in FIG. 3A, the signal line branched from the VDD signal line is instead caused to extend in the opposite direction away from the VSS signal line, for example. In this case, however, it is necessary to change the arrangement of the terminals in the pad 15 accordingly.

### Second Embodiment

While the propagation delay adjustment circuit 30 is provided in the LCD panel 16 in the first embodiment, the propagation delay adjustment circuit 30 can be provided within the driving IC 11. In the second embodiment, a structure in which a circuit for performing propagation delay adjustment is provided within the driving IC 11 will be described.

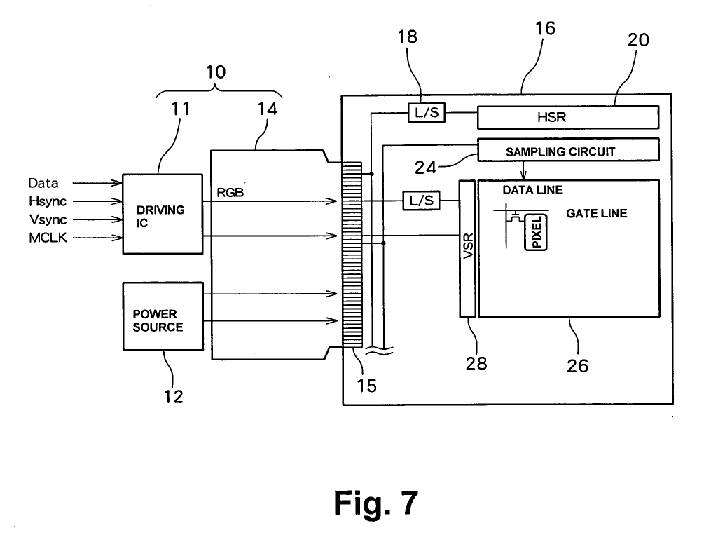

FIG. 7 shows the structure according to the second embodiment, which differs from the structure shown in FIG. 1 in that the propagation delay adjustment circuit 30 does not exist within the LCD panel 16 and a phase switching circuit 31 having a function similar to that of the propagation delay adjustment circuit 30 is provided within the driving IC.

The driving IC 11, similar to that shown in FIG. 1, includes a timing controller (T/C) for generating the above-described horizontal clock (HCLK), horizontal start pulse (HST), vertical clock (VCLK), vertical start pulse (VST), or the like in accordance with Hsync, Vsync, and dot clock (DOTCLK). The DOTCLK is supplied to an H counter via a driver circuit. The H counter counts DOTCLK in each 1 H period, and outputs the count value to a decoder, which decodes the pulse signal and outputs the pulse signal as HCLK via a logical gate. Further, another decoder obtains the timing immediately before the start of 1 H period based on the count value, and generates a pulse signal. The pulse signal decoded by the decoder is also output as HST via the logical gate. VCLK and VST are also generated and output in the similar manner.

Further, the driving IC 11 also includes a phase switching circuit 31 for switching the phase of HCLK thus generated between two levels. The phase switching circuit 31 has an arbitrary structure and may have a structure, for example, as shown in FIG. 2, including two delay circuits 34 and 36 for generating HCLK having a relatively advanced phase and HCLK having a relatively delayed phase, respectively, and change-over switches 32 and 38 for selectively switching between the delay circuits 34 and 36 for outputting HCLK. The driving IC 11 includes a switching terminal to which an external switching signal is input, and the switching signal is supplied to the change-over switch via the switching terminal. In accordance with this switching signal, the change-over switch selectively switches between the two delay circuits 34 and 36 for outputting either one of two signals having the advanced and delayed phases. The switching signal is supplied from the LCD panel 16 side, and more particularly from the FPC 14 side.

The FPC 14 includes a switching signal line for supplying the switching signal to the phase switching circuit 31 of the driving IC 11. The switching signal line is branched from either a VDD signal line or a VSS signal line within the FPC 14. Which of the VDD signal line and the VSS signal line the switching signal line is branched from is set depending on the degree of the delay characteristics of the LCD panel 16.

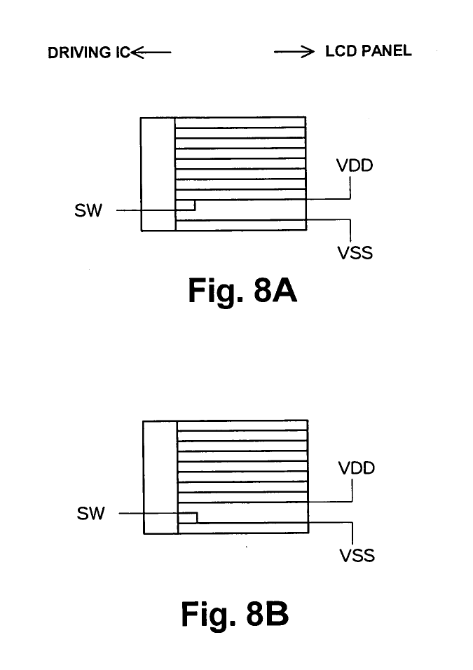

FIGS. 8A and 8B schematically show the structures of the FPC 14 of FIG. 7. The FPC 14 includes a plurality of signal lines for supplying the various signals from the driving IC 11 and the reference power source 12 to the LCD panel 16. Here, either the VDD signal line or the VSS signal line diverges in the middle to form the switching signal line, which is used for supplying the switching signal to the driving IC 11. FIG. 8A shows a case where the switching signal line is branched from the VDD signal line and the level of the switching signal SW is a VDD level, i.e. H level. On the other hand, FIG. 8B shows a case where the switching signal line is branched from the VSS signal line and the level of the switching signal SW is a VSS level, i.e. L level. As such, selection among the plurality of (two in this embodiment) delay circuits within the phase switching circuit 31 of the driving IC 11 can be performed by setting the signal level of the switching signal SW to either H or L. Further, the FPC 14 originally includes the VDD signal line for supplying a voltage signal of high potential supplied from the reference power source 12 to the LCD panel 16 and the VSS signal line for supplying a voltage signal of low potential to the LCD panel 16. According to the present embodiment, the above features are particularly noticed, and the originally existing signal lines within the FPC 14 are used, rather than providing an additional circuit for generating the switching signal within the LCD panel 16 or outside the LCD panel 16, thereby achieving selection among the delay circuits without unnecessarily increasing the number of elements. More specifically, the FPC 14 having the structure shown in FIG. 8A and the FPC 14 having the structure shown in FIG. 8B are prepared in advance, and when the delay characteristics of the LCD panel 16 are good as a result of measurement, one end of the FPC 14 shown in FIG. 8B can be connected to the pad 15 of the LCD panel 16, whereas when the delay characteristics of the LCD panel 16 are poor as a result of measurement, one end of the FPC 14 shown in FIG. 8A can be connected to the pad 15 of the LCD panel 16. The other end of the FPC 14 is connected to the driving IC 11, and the switching signal line of the FPC 14 is connected to the switching terminal of the driving IC 11. As such, a switching signal in accordance with the propagation delay characteristics of the LCD panel 16 is supplied to the switching terminal of the driving IC, which then outputs either one of two HCLKs having fast and slow phases in accordance with the switching signal. Consequently, with respect to the LCD panel 16 having good delay propagation delay characteristics, HCLK having a relatively delayed phase is output, whereas with respect to the LCD panel 16 having poor delay propagation delay characteristics, HCLK having a relatively advanced phase is output, and the output HCLK is supplied to the HSR 20 of the LCD panel 16.

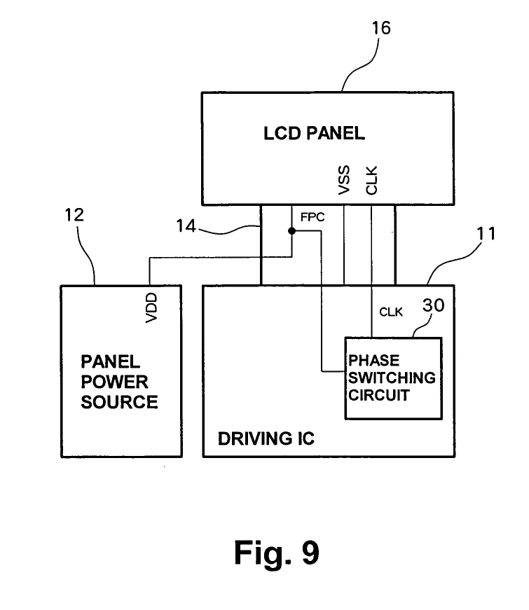

FIG. 9 shows the structure in which the driving IC 11, the reference power source (panel power source) 12, and the LCD panel 16 are connected by the FPC 14. In this case, the LCD panel 16 has poor propagation delay characteristics, and the FPC 14 is the FPC 14 shown in FIG. 8A in which the switching signal line is branched from the VDD signal line. The switching signal line of the FPC 14 is connected to the switching terminal of the driving IC 11, and the switching signal from the FPC 14 is supplied to the phase switching circuit 31 of the driving IC 11 via the switching terminal. As the switching signal has a VDD level, i.e. a H level, the delay circuit 34 in the phase switching circuit 31 is selected to thereby generate and output HCLK having a relatively advanced phase. The HCLK having relatively advanced phase is then supplied to the HSR 20 of the LCD panel 16 via the clock signal line of the FPC 14. Here, while the HCLK is caused to be -delayed in the LCD panel 16 due to the poor propagation delay characteristics of the LCD panel 16, the propagation delay in the LCD panel 16 is cancelled because the HCLK originally having an advanced phase was supplied from the driving IC 11, whereby the video signal can be sampled at the optimal sampling timing such that display data can be supplied to the data line.

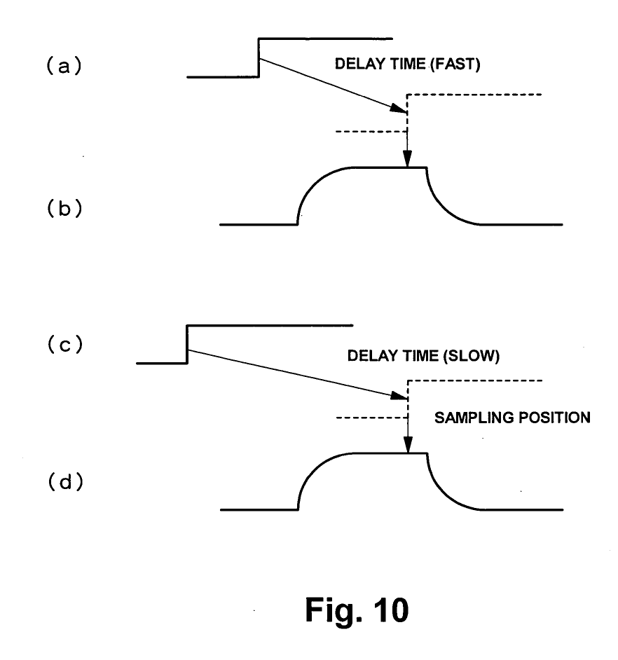

FIG. 10 shows the sampling timing of the HSR 20 and the sampling circuit 24 in a case where the phase of HCLK has been adjusted by switching control of the phase switching circuit 31 within the driving IC 11. Specifically, the figures (a) and (b) are timing charts in the case of the LCD panel 16 having good propagation delay characteristics (i.e. the delay time is fast), and HCLK having a delayed phase is supplied from the driving IC 11 via the delay circuit 36 as shown in the figure (a). The HCLK is then caused to be delayed by a predetermined time amount T1 within the LCD panel 16, as a result of which the optimal sampling timing in which the video signal reaches a fixed level is achieved as shown in the figure (b). The figures (c) and (d), on the other hand, are timing charts in the case of the LCD panel 16 having poor propagation delay characteristics (i.e. the delay time is slow), and HCLK having an advanced phase is supplied from the driving IC 11 via the delay circuit 34 as shown the figure (c) (i.e. the HCLK rises at a timing earlier than the HCLK of the figure (a)). While the HCLK is then caused to be delayed by a predetermined time amount T2 (T1<T2) within the LCD panel 16, the delay amount corresponding to (T2−T1) is substantially cancelled because the phase of the HCLK has been originally advanced. Consequently, as shown in the figure (d), the optimal sampling timing which is substantially the same as that in the figure (b) can be achieved.

Here, because both T1 and T2 vary depending on each LCD panel 16, and also because the phase switching circuit 31 within the driving IC 11 is configured to selectively output one of two HCLKs having a predetermined phase difference, it is difficult to completely cancel the delay amount (T2−T1). However, while an LCD panel 16 with poor propagation delay characteristics was conventionally treated as a defective product even if it is of the same model as normal products, with the above structure, even such an LCD panel 16 is not wasted because sampling can be achieved in the period in which the level of the video signal reaches a fixed level by outputting HCLK having an advanced phase.

As described above, according to the second embodiment, the phase switching circuit 31 is provided within the driving IC 11 and switching control of the phase switching circuit 31 is performed in accordance with the switching signal generated in the FPC 14, so that it is possible to adaptively adjust the sampling timing in accordance with the amount of the delay characteristics of the LCD panel 16 to thereby achieve sampling of the video-signal at the optimal timing. Further, because the switching signal used for switching control of the phase switching circuit 31 is branched from the VDD signal or the VSS signal within the FPC 14, it is possible to reliably switch the sampling timing in accordance with the LCD panel 16 with a simple structure and without increase in the number of elements.

While the above structure may be applied to LCD display apparatuses with high driving frequencies and high resolution, it may be also applied to any active matrix display apparatuses independently of the driving frequency.

Further, while in the above example, a switching signal is generated by branching from the voltage signal supplied from the reference power source 12, VDD of the reference power source 12 is a relatively high voltage (e.g. 8V). Accordingly, if a high voltage cannot be supplied and only a low voltage signal can be supplied to the driving IC 11, a structure in which a switching signal is branched in the FPC 14 from a VDD signal (3V, for example) supplied from the driving IC 11 to the FPC 14 and the switching signal thus generated is supplied to the switching terminal of the driving IC 11 may be adopted. FIG. 11 shows the structure in such a case. In this structure, a VDD signal supplied from the driving IC 11 is fed back from the FPC 14 to the switching terminal, and switching control of the phase switching circuit 31 is performed by the VDD signal.

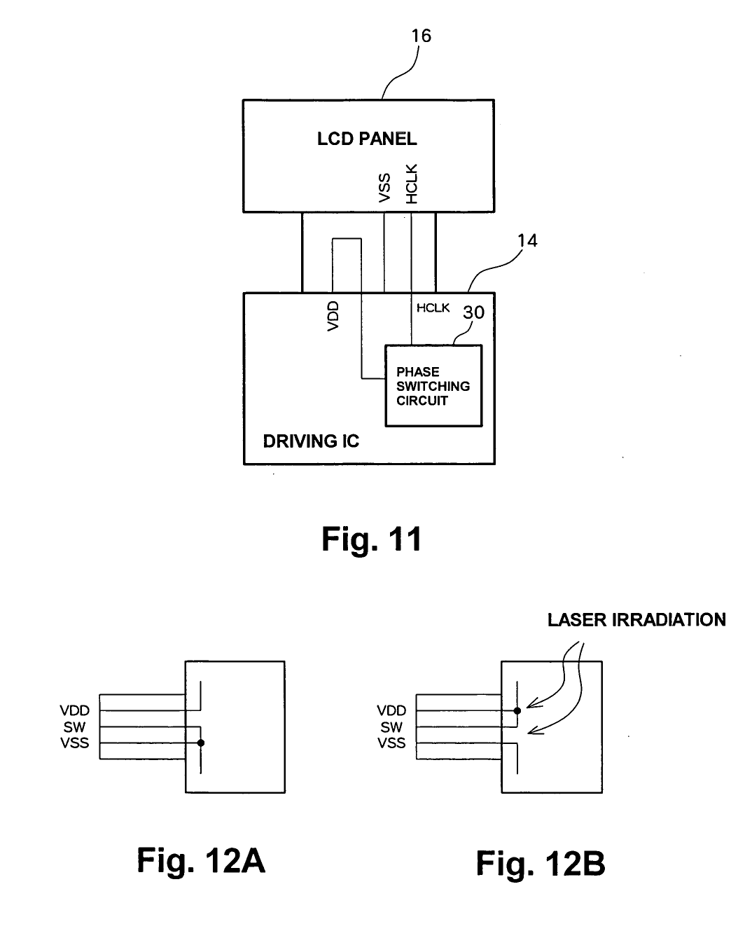

Further, in the above examples, the switching signal is generated by branching from either VDD or VSS within the FPC 14. However, because VDD and VSS are supplied to the LCD panel 16, the switching signal may be branched from either VDD or VSS within the LCD panel 16, not within the FPC 14. The switching signal which is branched within the LCD panel 16 is then supplied to the switching terminal of the driving IC 11 via the switching signal line within the FPC 14. In the LCD panel 16, the VDD signal line and the VSS signal line, which are insulated from each other by an interlayer insulating film such as SiO₂, form a multi-layered structure. Accordingly, in a case where a multilayer structure of the VDD signal line/first interlayer insulating film/switching signal line/second interlayer insulating film/VSS signal line, for example, is formed within the LCD panel 16, when a switching signal line is branched from the VDD signal line, the first interlayer insulating film is broken by laser irradiation or the like to thereby short-circuit the VDD signal line and the switching signal line, and when a switching signal line is branched from the VSS signal line, the second interlayer insulating film is broken by laser irradiation or the like to thereby short-circuit the VSS signal line and the switching signal line. Alternatively, the VSS signal line and the switching signal line are short-circuited in the default state, and the LCD panel 16 having good propagation delay characteristics may be used in this default state and HCLK having a delayed phase may be supplied from the driving IC 11 to the LCD panel 16, whereas in the case of an LCD panel having poor propagation delay characteristics, connection between the VSS signal line and the switching signal line may be broken for disconnection by laser irradiation and also the insulating film provided between the switching signal line and the VDD signal line may be broken by laser irradiation. These structures are shown in FIGS. 12A and 12B. Specifically, FIG. 12A shows the LCD panel 16 in the default state in which the VSS signal line and the switching signal line are short-circuited within the LCD panel 16. In this state, the level of the switching signal is low (L) and HCKL having a delayed phase is supplied from the driving IC 11. FIG. 12B shows, on the other hand, the LCD panel 16 having poor propagation delay characteristics, in which the VSS signal line and the switching signal line are disconnected by laser irradiation, and also the insulating film disposed between the VDD signal line and the switching signal line is broken for short circuit. In this case, the level of the switching signal is high (H), and HCLK having an advanced phase is supplied from the driving IC 11.

Further, in the second embodiment, when the switching signal line is branched from either the VDD or VSS signal line, the branch point may be any point within the FPC 14 or within the LCD panel 16. Accordingly, in the case of branching within the FPC 14, the switching signal line may be branched from the VDD or VSS signal line at a point which is close to the driving IC 11 as shown in FIGS. 8A and 8B, or it is also possible to cause the switching signal line to be branched from the VDD and VSS signal lines at different points so that the two types of FPCs 14 shown in FIGS. 8A and 8B can be discriminated easily, for example. It may also be preferable to cause the switching signal line which is branched from either the VDD or VSS signal line to extend in a direction different from the direction of the other signal line which is not branched, so as to prevent short-circuit with respect to the other signal line. For example, rather than causing the signal line which is branched from the VDD signal line to extend between the VDD signal line and the VSS signal line as in the example shown in FIG. 8A, the signal line branched from the VDD signal line is instead caused to extend in the opposite direction away from the VSS signal line, for example. In this case, however, it is necessary to change the arrangement of terminals of the pad 15 accordingly.

In addition, in the structure according to the second embodiment, HCLK having an advanced phase is output from the driving IC 11 when the switching signal line is branched from the VDD signal line and the level of the switching signal is H, and HCLK having a delayed phase is output from the driving IC 11 when the switching signal line is branched from the VSS signal line and the level of the switching signal is L. However, it is also possible to cause HCLK having a delayed phase to be output from the driving IC 11 when the switching signal line is branched from the VDD signal line and the level of the switching signal is H. It would be also preferable to adopt a structure in which, taking into consideration disconnection of the switching signal line or the like, HCLK having a delayed phase is caused to be output from the driving IC 11 when the level of the switching signal is L.

While the preferred embodiments of the present invention have been described using specific terms, such description is for illustrative purposes only, and it is to be understood that changes and variations may be made without departing from the spirit or scope of the appended claims.

What is claimed is:

1. A driving circuit for driving an active matrix display apparatus, the driving circuit comprising:
a flexible printed circuit for supplying a high potential power source voltage signal, a low potential power source voltage signal, and a clock signal to the display apparatus,
wherein
the flexible printed circuit generates a switching signal by branching from either the high potential power source voltage signal or the low potential power source voltage signal and supplies the switching signal to a change-over switch which is provided within the display apparatus for selectively switching between a first delay circuit which causes the clock signal supplied from the flexible printed circuit to be delayed by a first delay amount and a second delay circuit which causes the clock signal to be delayed by a second delay amount, wherein the first delay amount is less than the second delay amount.

2. A flexible printed circuit which supplies a driving signal for driving an active matrix display apparatus, the flexible printed circuit comprising:
a high potential power source voltage signal line for supplying a high potential power source voltage signal to the display apparatus;
a low potential power source voltage signal line for supplying a low potential power source voltage signal to the display apparatus;
a clock signal line for supplying a clock signal to the display apparatus; and
a switching signal line which is formed by branching from either the high potential power source voltage signal line or the low potential power source voltage signal line, the switching signal line supplying a switching signal which selectively switches among a plurality of delay circuits provided within the display apparatus to the display apparatus.

3. An active matrix display apparatus, comprising:
a display panel including active matrix type pixels; and
a flexible printed circuit for supplying a driving signal including a clock signal and a voltage signal for driving the display panel to the display panel,
wherein
the display panel includes:
a first delay circuit which causes the clock signal supplied from the flexible printed circuit to be delayed by a first delay amount;
a second delay circuit which causes the clock signal supplied from the flexible printed circuit to be delayed by a second delay amount, wherein the first delay amount is less than the second delay amount; and
a change-over switch for selectively switching between the first delay circuit and the second delay circuit in accordance with a switching signal;
and the flexible printed circuit includes:
a switching signal line for supplying the switching signal which is branched from the voltage signal to the change-over switch.

4. A driving circuit for driving an active matrix display apparatus, the driving circuit comprising:
a driving IC which outputs a clock signal;
a power source which outputs a voltage signal; and
a flexible printed circuit which supplies the voltage signal and the clock signal to the display apparatus and which generates a switching signal by branching from the voltage signal and supplies the switching signal to a change-over switch which is provided within the display apparatus for selectively switching between a first delay circuit which causes the clock signal supplied from the flexible printed circuit to be delayed by a first delay amount and a second delay circuit which causes the clock signal to be delayed by a second delay amount, wherein the first delay amount is less than the second delay amount.

5. A driving circuit for driving an active matrix display apparatus, the driving circuit comprising:
a driving IC which selectively outputs a clock signal having a different phase in accordance with a switching signal;
a power source which outputs a voltage signal; and
a flexible printed circuit which supplies the voltage signal from the power source and the clock signal from the driving IC to the display apparatus and which supplies, as the switching signal, the voltage signal to the driving IC.

6. A flexible printed circuit which supplies a driving signal for driving an active matrix display apparatus, the flexible printed circuit comprising:
a high potential power source voltage signal line for supplying a high potential power source voltage signal to the display apparatus;
a low potential power source voltage signal line for supplying a low potential power source voltage signal to the display apparatus;
a clock signal line for supplying a clock signal to the display apparatus; and
a switching signal line which is formed by branching from either the high potential power source voltage signal line or the low potential power source voltage signal line, the switching signal line supplying a switching signal to a driving IC which generates the clock signal for changing a phase of the clock signal.

7. An active matrix display apparatus, comprising:
a display panel including active matrix type pixels;
a driving IC which selectively outputs a clock signal ;having a different phase in accordance with a switching signal; and
a flexible printed circuit which supplies a driving signal including the clock signal and a voltage signal to the display panel and which supplies the switching signal generated by branching from the voltage signal to the driving IC for changing a phase of the clock signal.
